(19) United States
(12) Patent Application Publication
(10) Pub. No.: US 2011/0007848 A1
(43) Pub. Date: Jan. 13, 2011

(54) METHOD FOR CALIBRATING IQ MATCHING OF RECEIVER

(75) Inventors: KENG LEONG FONG, SUNNYVALE, CA (US); ALBERT JERNG, LOS GATOS, CA (US); CHUNGWEN LO, PALO ALTO, CA (US)

Correspondence Address: Sawyer Law Group, P.C., P.O. Box 51418, Palo Alto, CA, 94303, US

(73) Assignee: RALINK TECHNOLOGY (SINGAPORE) CORPORATION, SINGAPORE (SG)

(21) Appl. No.: 12/498,612

(22) Filed: Jul. 7, 2009

(51) Int. Cl. H04L 27/06; H04B 17/00

(52) U.S. Cl. 375/322; 455/226.1

(57) ABSTRACT

A method and system for calibrating the mismatch between I data and Q data of a receiver is disclosed. The receiver includes an amplifier, first and second mixers coupled to the amplifier, an oscillator for driving the first and second mixers; and first and second filters coupled to the first and second mixers. The method comprises turning off the amplifier; and injecting a signal into the first and second mixers. The method also requires measuring the amplitude and phase information of the I and Q data from the first and second mixers based upon the injected signal to provide mismatch information and utilizing the mismatch information to compensate the I data and the Q data during normal operating mode. In a method and system in accordance with an embodiment, the IQ mismatch of a receiver can be measured and compensated. This allows direct-conversion architecture, which is known to have IQ mismatch problem, to be used. Furthermore, if this calibration method is applied to other receiver architectures, the yield loss due to IQ mismatch can be minimized.

### FIELD OF THE INVENTION

The present invention relates generally to receivers and more to calibrating the mismatch between I data and Q data in such receivers.

### BACKGROUND OF THE INVENTION

Receivers are utilized in a variety of environments. They are utilized, for example, in RF transceivers in various applications. In a receiver, during normal operating mode, a radio-frequency (RF) input signal amplified by a low-noise amplifier (LNA) is downconverted to in-phase (I) and quadrature-phase (Q) baseband signals by an I mixer and a Q mixer respectively. The local oscillator (LO) ports of the I mixer and the Q mixer are driven by an I local-oscillator (LO) signal and Q LO signal, respectively. The I mixer LO signal and Q mixer LO signal are orthogonal (90 degree phase shift) to each other. An I baseband signal and Q baseband signal are then amplified and filtered by baseband filters and variable-gain amplifiers (VGA) before they are digitized by a pair of analog-to-digital converters (ADCs). Due to random process variation, the I path and Q path are not perfectly matched. This results in phase and amplitude mismatches in the I data and Q data, degrading the reception quality and hence increasing the bit-error rate in a digital communication system.

Accordingly, what is desired is a system and method to address the IQ mismatch issues The system and method should be cost effective, easily implemented and adaptable to existing receivers. The present invention addresses such a need.

### SUMMARY OF THE INVENTION

A method and system for calibrating the mismatch between I data and Q data of a receiver is disclosed. The receiver includes an amplifier, first and second mixers coupled to the amplifier, an oscillator for driving the first and second mixers; and first and second filter coupled to the first and second mixers. The method and system comprise turning off the amplifier; and injecting a signal into the first and second mixers. The method and system also includes measuring the amplitude and phase information of the I and Q data from the first and second mixers based upon the injected signal to provide mismatch information and utilizing the mismatch information to compensate the I data and the Q data during normal operating mode.

In a method and system in accordance with an embodiment, the IQ mismatch of a receiver can be measured and compensated. This allows, for example, for direct-conversion architecture, which is known to have IQ mismatch problem, to be utilized in an effective manner. Furthermore, if this calibration method is applied to other receiver architectures, the yield loss due to IQ mismatch can be minimized.

### BRIEF DESCRIPTION OF DRAWINGS

The accompanying drawings illustrate several embodiments of the invention and, together with the description, serve to explain the principles of the invention. One skilled in the art will recognize that the particular embodiments illustrated in the drawings are merely exemplary, and are not intended to limit the scope of the present invention.

FIG. 1 is a block diagram of the architecture of a direct-conversion receiver in accordance with an embodiment.

FIG. 2 is a block diagram of the architecture of a heterodyne architecture receiver in accordance with an embodiment.

### DETAILED DESCRIPTION OF PREFERRED EMBODIMENTS

The present invention relates generally to receivers and more to calibrating the mismatch between I data and Q data in such receivers. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

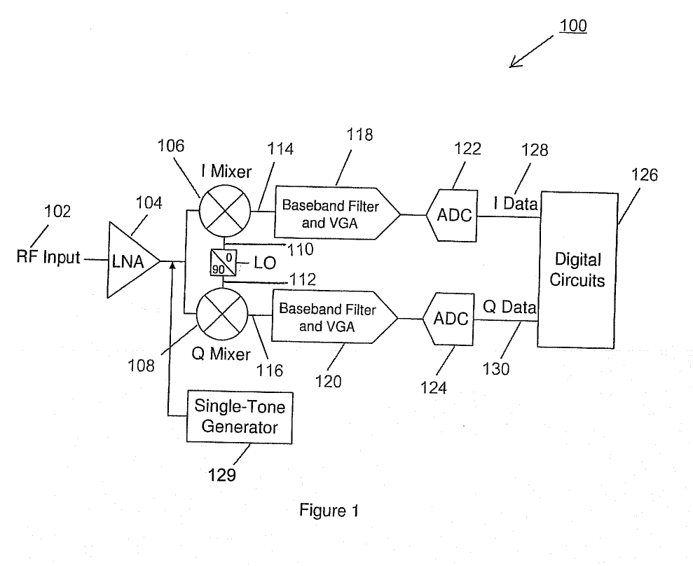

FIG. 1 is a block diagram of the architecture of a direct-conversion receiver 100 in accordance with an embodiment. FIG. 1 includes an RF input 102, a low-noise amplifier (LNA) 104, an I mixer 106, a Q mixer 108, local-oscillator (LO) signals 110 and 112, a single-tone generator 129, an I path 114 and a Q path 116, baseband filters and VGAs 118 and 120, analog-to-digital converters (ADCs) 122 and 124 for I data 122 and for Q data 124, and digital circuits 126.

As before mentioned, in normal operating mode, the radio-frequency (RF) input signal 102 amplified by the low-noise amplifier (LNA) 104 is downconverted to in-phase (I) 114 and quadrature-phase (Q) 116 baseband signals by the I mixer 106 and Q mixer 108 respectively. The LO ports of the I mixer 106 and Q mixer 108 are driven by the I local-oscillator (LO) signal 110 and Q local-oscillator (LO) signal 112, respectively. The I LO signal 110 and Q LO signal 112 are orthogonal (90 degree phase shift) with each other. The I baseband signal 114 and Q baseband signal 116 are then amplified and filtered by the baseband filters and variable-gain amplifiers (VGAs) 118 and 120 before they are digitized by a pair of analog-to-digital converters (ADCs) 122 and 124. Due to random process variation, the I path and Q path are not perfectly matched. This results in phase and amplitude mismatches in the I data 128 and Q data 130, degrading the reception quality and hence increasing the bit error rate in the receiver 100 of a digital communication system.

To solve this IQ mismatch problem, the IQ amplitude and phase mismatch needs to be measured and compensated. In an embodiment to measure this IQ mismatch, a single-tone generator 129 is utilized in the receiver during calibration mode. In calibration mode, the LNA 104 is turned off and the single-tone generator 129 is used to inject a sinusoidal signal, the frequency of which is different from the LO frequency, to the input ports of the I mixer 106 and the Q mixers 108. In an ideal situation where the I and Q signal paths are perfectly matched, the resulting sinusoidal I and Q data have exactly the same amplitude and 90-degree phase difference. In a practical situation, however, the mismatches in the I and Q signal paths cause the amplitude and phase of the I data and Q data to be different. This amplitude and phase mismatch information can be measured by the digital circuits 126 during the calibration mode and then can be used to compensate the I data and Q data during the normal operating mode.

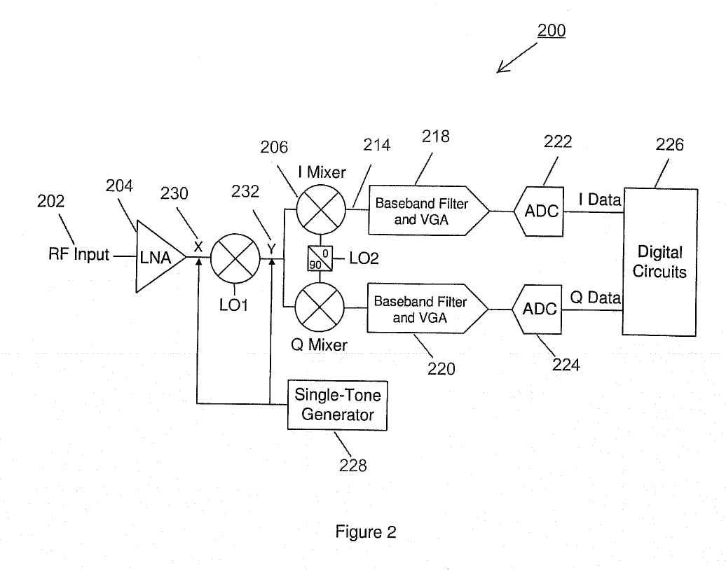

Besides the particular implementation described above, there are several variations to this technique. Although FIG. 1 is a block diagram of the architecture of a direct-conversion receiver 100, this IQ mismatch measurement technique can be applied to other receiver architectures as well, such as the block diagram of heterodyne architecture 200 as shown in FIG. 2. In this case, the signal-tone generator 228 injects a signal to either the input port (node X) 230 or the output port (node Y) 232 of the first mixer. Some heterodyne architectures also use image-rejection architecture (not shown in FIG. 2) as the first mixer. Beside injecting the signal into the input ports of the mixers 230 and 232, the single-tone generator 228 can be modified to inject a signal to the input port of the LNA (not shown) in an alternate design. In this case, the LNA cannot be turned off. There are many cost-effective ways to implement the integrated single-tone generators 129 and 228. One example is ring oscillator locked by an integer-N phase-locked loop (PLL) circuit (also not shown).

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for calibrating the mismatch between I data and Q data of a receiver, the receiver including an amplifier, first and second mixers coupled to the amplifier, an oscillator for driving the first and second mixers; and first and second filter coupled to the first and second mixers; the method comprising:
turning off the amplifier;
injecting a signal into the first and second mixers; and
measuring the amplitude and phase information of the I and Q data from the first and second mixers based upon the injected signal to provide mismatch information and utilizing the mismatch information to compensate the I data and the Q data during normal operating mode.

2. The method of claim 1 wherein the injected signal comprises a sinusoidal signal.

3. The method of claim 1 wherein the injected signal is provided from a single-tone generator.

4. The method of claim 1 wherein the single-tone generator comprises a ring oscillator locked by a phase-locked loop circuit.

5. The method of claim 1 wherein the receiver comprises a direct-conversion receiver.

6. The method of claim 1 wherein the receiver comprises a heterodyne receiver.

7. A receiver comprising:
an amplifier,
first and second mixers coupled to the amplifier,
an oscillator for driving the first and second mixers; and
first and second filters coupled to the first and second mixers for processing an I signal and a Q signal;
first and second analog-to-digital converters for receiving the I signal and the Q signal from the first and second filters, and converting them to I and Q data; and
a signal generator for injecting a signal into first and second mixers; wherein the amplitude and phase information of the I and Q data from the first and second analog-to-digital converters are measured by the digital circuits to provide mismatch information and the mismatch information is utilized to compensate the I and Q data during normal operating mode.

8. The receiver of claim 7 wherein the injected signal comprises a sinusoidal signal.

9. The receiver of claim 7 wherein the signal generator comprises a single-tone generator.

10. The receiver of claim 9 wherein the single-tone generator comprises a ring oscillator locked by a phase-locked loop circuit.

11. A heterodyne receiver comprising:
an amplifier,
a first mixer coupled to the amplifier,
second and third mixers coupled to the first mixer,
an oscillator for driving the second and third mixers; and
first and second filters coupled to the second and third mixers for processing an I signal and a Q signal;
first and second analog-to-digital converters for receiving the I signal and the Q signal from the first and second filters, and converting them to I and Q data; and
a signal generator for injecting a signal into an input or an output port of the first mixer wherein the amplitude and phase information of the I and Q data from the first and second analog-to-digital converters are measured by the digital circuits to provide mismatch information and the mismatch information is utilized to compensate the I and Q data during normal operating mode.

12. The heterodyne receiver of claim 11 wherein the injected signal comprises a sinusoidal signal.

13. The heterodyne receiver of claim 11 wherein the signal generator comprises a single-tone generator.

14. The heterodyne receiver of claim 13 wherein the single-tone generator comprises a ring oscillator locked by a phase-locked loop circuit.
